(19) United States
(12) Patent Application Publication
(10) Pub. No.: US 2011/0155832 A1
(43) Pub. Date: Jun. 30, 2011

(54) SLIDING MEMBER THAT IS PIVOTLY ATTACHED ALONG ONE SIDE TO AN OPEN ROTOR

(75) Inventor: J.P.A.J. Van der Zanden, Klimmen (NL)

(73) Assignee: SYNSIDE MAATSCHAP, Hasselt (BE)

(21) Appl. No.: 13/002,898

(22) PCT Filed: Jul. 10, 2009
(86) PCT No.: PCT/NL2009/000145

§ 371 Date: Jan. 6, 2011

(30) Foreign Application Priority Data
Jul. 15, 2008 (NL) 1035706
Oct. 20, 2008 (NL) 1036088
Mar. 22, 2009 (NL) 1036747

(51) Int. Cl. B02C 15/00

(52) U.S. Cl. 241/205

(57) ABSTRACT

The invention relates to the field of the acceleration of material, in particular a stream of granular or particulate material, with the aid of centrifugal force, with, in particular, the aim of causing the accelerated grains or particles to collide with an impact member at such a velocity that they are crushed, and involves at least one sliding member (2) that is pivotly attached and centrifugally locked to the rotor (1) only along the side of the sliding member that is facing the rotor such that the attachment members (8,9) are located at a position essentially below the plane (22) with on it the outer edge (12) of the centre face (5). This has the advantage that the wear material is more effectively used such that less throw-away material remains, more sliding members can be placed on the rotor, a longer operation time is achieved, attachment members are not damaged when the sliding member wears through and that replacement is easier and special securing can be avoided.

### FIELD OF THE INVENTION

The invention relates to the field of the acceleration of material, in particular a stream of granular or particulate material, with the aid of centrifugal force, with, in particular, the aim of causing the accelerated grains or particles to collide with an impact member at such a velocity that they are crushed, but other possible applications are not excluded.

### BACKGROUND TO THE INVENTION

A stream of particle material can be accelerated on an open throw rotor with the aid of centrifugal force. With this technique the material is fed onto the central part of the rotor that rotates rapidly about a vertical axis of rotation, which material is then collected by one or more sliding members, which are positioned around the central part on top of the rotor, hence the name open throw rotor, which is known from U.S. Pat. No. 6,149,086. This type of sliding member—here called ‘standard’ sliding member—is widely used but has some serious shortcomings. The sliding member is fixedly attached to the rotor along the standing side face opposite of the sliding face with the aid of an attachment member that is positioned on top of the rotor. The attachment member stretches behind the sliding member and limits the space available for free transport of particles between the sliding members and along the sliding faces, hence limits the number of sliding members that can effectively be positioned on the rotor. The sliding members allow for one-way operation only and this limits optimal utilization of the wear material. The attachment member gets damaged when the sliding member wears off too far and mounting of a new attachment member is time consuming and expensive.

The strength of the sliding members can be increased by providing them with a steel strengthening plate, as is known from U.S. Pat. No. 7,051,964, which is drawn in the name of the inventor and allows for more effective use of the wear material. An important development with sliding members involves cavities and pockets along the sliding face as well as ceramic inserts to prolong operation time. Such sliding member is known from WO 02/09878.

The sliding member can also be provided with two sliding faces, that is with a symmetrical configuration, as is known form U.S. Pat. No. 3,767,127. This sliding member is V-shaped with the point directed towards the axis of rotation and bears on a V-shaped support member, against which it anchors firmly under the influence of centrifugal force. This has the advantage that the rotor is operational in both directions as a result of which the tool life is doubled and the wear material is consumed more effectively, whilst as a result of the simple mounting the parts are very easy to replace and do not have to be specially secured—are actually centrifugally locked. The problem, however, is that the stresses concentrate in the V-shaped pointed part, the more so when the V wears off. As a result fracture easily takes place at the location of the V-shaped point when wear progresses. U.S. Pat. No. 3,652,023 discloses a V-shaped sliding member that is constructed as a triangle closed all round, which is provided with an opening in the middle, with the aid of which the sliding member is mounted. A sliding member of this type is stronger than the known open V-shaped sliding member, but the configuration demands a large amount of additional wear material that cannot be utilized. These types of V-shaped sliding members are consequently not really effective. It is however clear that a symmetrical sliding member has major advantages. Sliding members can also be pivotly attached to the rotor, normally between two rotor blades, that is a closed rotor, for example known from U.S. Pat. No. 5,381,974.

### AIM OF THE INVENTION

The aim of the invention is, therefore, to provide an open throw rotor as described above that does not have these disadvantages, or at least displays these to a lesser extent; that is, that the wear material is more effectively used such that less throw-away material remains which saves costs while a longer operation time is achieved, that more sliding members can be positioned on the rotor increasing the operation time accordingly, that attachment members are not damaged when the sliding member wears through and that replacement is easier and special securing can be avoided through application of centrifugal locking.

This aim is achieved with a rotor that rotates about a vertical axis of rotation and is provided with a centre face where particle material is metered on the rotor and with at least one sliding member for accelerating the material under influence of centrifugal force, which sliding member is pivotly attached to the rotor only along the side of the sliding member that is facing the rotor with the aid of attachment members that are located at a position essentially below the plane with on it the outer edge of the centre face in such a way that the position of the sliding member is secured through centrifugal locking that does not hamper pivoting movement of the sliding member about a second axis of rotation when the sliding face wears off and that the centre of gravity shifts in transversal direction. The second axis of rotation is essentially parallel to the first axis of rotation and is positioned at a shorter radial distance from the first axis of rotation than the centre of gravity of the sliding member when the sliding member is turned in its radial position.

According the invention, one side pivoting mounting and centrifugal locking can be achieved through attachment of the sliding member [1] on top of the rotor, [2] in an attachment space in the rotor, that is with the attachment members below the top face of the rotor and [3] with the attachment member partly in the rotor and partly on top of the rotor. A stepped rotor construction is preferred with attachment on top, that is, a stepped rotor were the centre face of the rotor is a level above the surrounding face that surrounds the centre face, with the sliding block attached on top of the surrounding face. With attachment in the rotor, the rotor has to be provided with an attachment space in the rotor such that the sliding block protrudes above the top face of the rotor. The invention allows for the possibility that the sliding member is carried by the rotor with the aid of a separate pivoting attachment member that is placed in the attachment space. Another possibility is that the pivot member is in the rotor and the lock member on top of the rotor.

One side pivoting attachment means that torsion stresses are largely avoided but rather high stresses can still develop in the attachment member, in particular the lock member. A special aim of the invention is to design and attach the sliding member in such way that stresses that are generated are limited.

The invention allows for the possibility that the sliding member is symmetrically designed relative to the radial plane from the axis of rotation, that is, with two sliding faces for two way operation.

The invention allows for the possibility that at least part the attachment members is made out of a structural material that has an appreciably greater tensile strength than the structural material from which the sliding block is made.

The invention allows for the possibility that the sliding face is provided with at least one open chamber that fills partly with particle material providing a partly autogenous sliding face.

The invention allows for the possibility that the sliding member is provided with a sliding face and an impact face for two-step acceleration of the material when the particles are simultaneously accelerated and loaded during co-rotating impact.

The invention allows for the possibility that the sliding block is partly composed out of a ceramic material—for example provided with ceramic inserts—or other types of wear resistant inserts and/or is provided with at least one hard metal piece—for example a tungsten carbide insert—at least somewhere along the sliding face or inside the sliding block.

### BRIEF DESCRIPTION OF THE DRAWINGS

For better understanding, the aims, characteristics and advantages of the device of the invention which have been discussed, and other aims, characteristics and advantages of the device of the invention, are explained in the following detailed description of the device of the invention in relation to accompanying diagrammatic drawings.

FIG. 1 shows, diagrammatically, a side view B-B from FIG. 2, from a first embodiment of a rotor with a first embodiment of the sliding members according the invention positioned on top of the rotor;

FIG. 2 shows, diagrammatically, a top view A-A from FIG. 1;

FIG. 3 shows, diagrammatically, a 3D top view from the rotor from FIG. 1;

FIG. 4 shows, diagrammatically, a 3D top view from the rotor from FIG. 3, indicating the way the sliding members are attached to the rotor;

FIG. 5 shows, diagrammatically, a 3D view form the sliding member from FIG. 1;

FIG. 6 shows, diagrammatically, a top view D-D from FIG. 7 of the sliding member from FIG. 5;

FIG. 7 shows a top view C-C from FIG. 6;

FIG. 8 shows, diagrammatically, a side view of the sliding member according the invention indicating the stress distribution;

FIG. 9 shows, diagrammatically, a top view of the sliding member of FIG. 8;

FIG. 10 shows, diagrammatically, a front of FIG. 9;

FIG. 11 shows a side view of the sliding member according the invention that indicates how the position of the centre of gravity is affected by the design;

FIG. 12 shows, diagrammatically, a side view F-F from FIG. 13, from a second embodiment of a rotor with a second embodiment of the sliding members according the invention positioned in an attachment space in the rotor, here with the aid of a separate first pivot part;

FIG. 13 shows, diagrammatically, a side view E-E from FIG. 12;

FIG. 14 shows, diagrammatically, a top view from the rotor from FIG. 13, indicating the way the sliding members are attached to the rotor;

FIG. 15 shows, diagrammatically, a 3D view form the sliding member from FIG. 12;

FIG. 16 shows, diagrammatically, a top view H-H from FIG. 17 of the sliding member from FIG. 15;

FIG. 17 shows, diagrammatically, a side view G-G from FIG. 16;

FIG. 18 shows, diagrammatically, a 3D view form the separate first pivot part from FIG. 12;

FIG. 19 shows, diagrammatically, a side view J-J from FIG. 20 of the separate first pivot part from FIG. 18;

FIG. 20 shows, diagrammatically, a top view I-I from FIG. 19;

FIG. 21 shows a 3D view from a third embodiment of a sliding member according the invention that is provided with a sliding face and an impact face.

FIG. 22 shows, diagrammatically, a top view L-L from FIG. 23 from the sliding members from FIG. 21;

FIG. 23 shows, diagrammatically, a side view K-K from FIG. 22;

### BRIEF DESCRIPTION OF THE DRAWINGS

For better understanding, the aims, characteristics and advantages of the device of the invention that have been discussed, and other aims, characteristics and advantages of the device of the invention, are explained in the following detailed description of the device of the invention in relation to accompanying diagrammatic drawings. A detailed reference to the preferred embodiments of the invention is given below. Examples thereof are shown in the appended drawings. Although the invention will be described together with the preferred embodiments, it must be clear that the embodiments described are not intended to restrict the invention to those specific embodiments. On the contrary, the intention of the invention is to comprise alternatives, modifications and equivalents which fit within the nature and scope of the invention as defined by appended claims. Many other configurations of one side pivoting sliding members according the invention that are positioned with the sliding members essentially on top of the rotor are possible and can be envisaged; some are discussed here and some are shown in the priority documents belonging to this document to which reference is made.

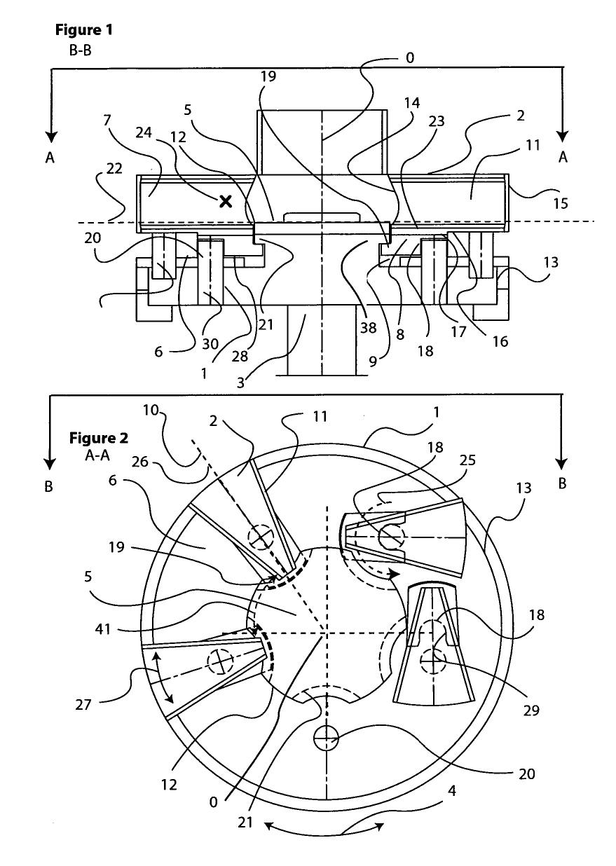

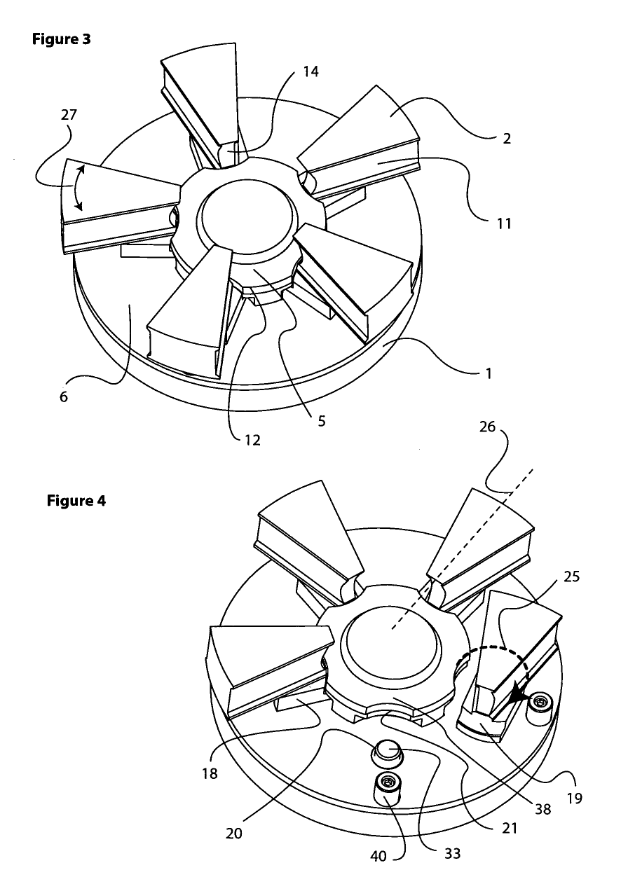

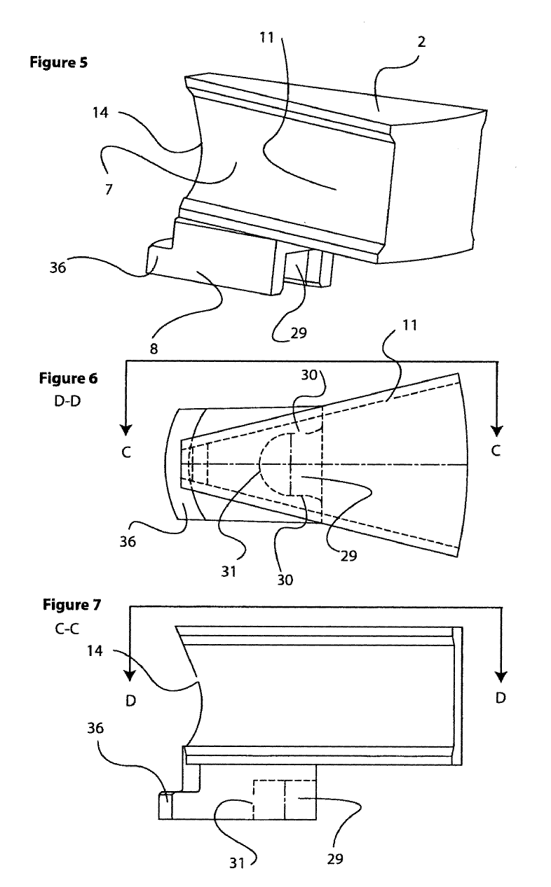

FIGS. 1 and 2 show, diagrammatically, a side view and a top view from a first embodiment of a rotor (1) according the invention that carries a first embodiment of a sliding member (2) according to the invention with FIGS. 3 and 4 showing two 3D views of the rotor (1). The rotor (1) is of open type and is carried by a shaft (3) and is rotatable about an essentially vertically directed first axis of rotation (0), here in two directions (4). Material is metered on the centre face (5) of the rotor (1) that extends around the first axis of rotation (0) to be collected by sliding members (2) that are carried by the rotor (1), positioned essentially around the outer edge (12) of the centre face (5) on top of the surrounding face (6) of the rotor (1) that surrounds the centre face (5). The sliding member (2), detailed in FIGS. 5, 6 and 7, comprises a sliding block (7) and a first attachment member (8) for attaching the sliding member (2) to a second attachment member (9) that is carried by the rotor (1) in such a way that the sliding block (7) can be exchanged for replacement because of wear. The attachment members (8)(9) are located at a position below the plane (22) with on it the outer edge (12) of the centre face (5). The sliding block (7) is here symmetrical relative to the radial plane (10) from the first axis of rotation (0) and provided with two sliding faces (11) that stretch into the direction of the outer border (13) of the rotor (1) between an inner face (14) that is directed towards the first axis of rotation (0), and an surrounding face (15) that is directed towards the outer border (13) of the rotor (1), for accelerating the material under influence of centrifugal force, and a bottom face (16) that that is directed towards the rotor (1) or more specific directed to the surrounding face (6). The first attachment member (8) is here positioned essentially underneath the sliding block (7) firmly joined with the sliding block (7) along the attachment part (17) of the bottom face (16) and is provided with a first pivot member (18) and a first lock member (19). The second attachment member (9) is provided with a second pivot member (20) and a second lock member (21), which second pivot member (20) fits the first pivot member (18), such that the sliding member (2) can be pivotly attached to the rotor (1)—that is, only along the attachment side (23) of the first attachment member (8) that faces the rotor (1)—such that the sliding member (2) pivots about a second axis of rotation (00) that is essentially parallel to the first axis of rotation (0) and is positioned at a shorter radial distance from the first axis of rotation (0) than the centre of gravity (24) of the sliding member (2) when the sliding member (2) is turned (25) in its radial position (26) when the first lock member (19) fits the second lock member (21) such that it secures the radial position (26) of the sliding member (2) through centrifugal locking, but does not hinder pivoting movement (27) of the sliding member (2) about the second axis of rotation (00) when the sliding face (11) wears off such that the centre of gravity (24) shifts in transversal direction.

More specific, the sliding member (2) is here attached essentially on top (28) of the surrounding face (15) of rotor (1) with a first pivot member (18) that here consists out of a horizontal pivot slit (29) in the first attachment member (8) that is open in the direction that faces the rotor (1) and stretches between two flank sides (30) in horizontal direction essentially centrally along the bottom face (16) of the sliding block (7) into the direction of the outer border (13) of the rotor (1) between a closed rounded end (31) that is positioned near to the inner face (14) and an open end (32) that faces the outer border (13) of the rotor (1). The second pivot member (20) consists here out of a standing circular cylindrical pivot bar (33) that protrudes upwards from the rotor (1) of which standing pivot bar (33) the axis coincides with the second axis of rotation (00), such that it fits the closed rounded end (31) of the pivot slit (29). Exchange of wear parts is extremely simple. As is shown in FIGS. 4 the sliding member (2) can slide in transversal position (34) with the open end (32) of pivot slit (29) over the standing pivot bar (33) against the closed rounded end (31) to be turned (25) about the standing pivot bar (33) into its radial position (26) such that the first lock member (19) fits the second lock member (21). The first lock member (19) consists here out of a first lock lip (36) that stretches from the interior side (37) of the first attachment member (8) into the direction of the first axis of rotation (0), and a lock block (38) that is here part of the rotor and is centrally positioned on the rotor (1) and is provided with the second lock member (9) that consists here out an open second lock slit (39) that faces the outer boarder (13) of the rotor (1) such that it fits the fist lock lip (36). The lock block (38) can also be a separate part that is attached to the rotor (1).

Part of the bottom face (16) hangs here freely above the surrounding face (15) and is here supported along the outer border (13) by a standing support bar (40) that protrudes upwards from the rotor (1)—but the invention allows for support by a hanging support bar (not shown here) that protrudes downwards from the attachment member. Provided with a stronger lock member support can be avoided.

One side pivoting sliding members like the first embodiment of the sliding member (3) are much more efficient than the ‘standard’ sliding members that are fixedly attached to the rotor along one of radial faces (discussed before). So avoids pivoting attachment torsion stresses in the sliding member (2). It also allows for two-way operation, which means that a much larger part of the wear material of the sliding block (7) can be effectively used. This reduces wear costs and increases lifetime of the sliding member (2). It also makes replacement very easy, at least much easier and faster than with the ‘standard’ sliding members—also because the sliding member 2) is centrifugally locked only. Leaving more free transport space (41) between the sliding members (2) it allows for wider sliding blocks (7) and when these become too heavy to handle, the rotor (1) can be provided with more sliding members (2)—here five—both measures further increase lifetime of the sliding member (2).

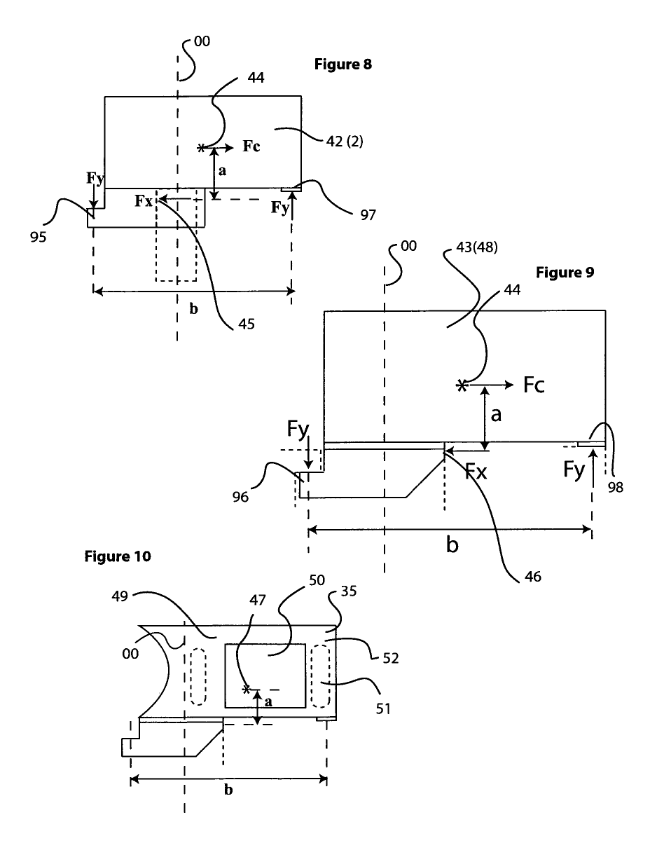

FIGS. 8, 9 and 10 shows, diagrammatically, the sliding member of the first embodiment (2)(42) from FIG. 1 and of the sliding member of the second embodiment (48)(43) from FIG. 12. indicating the forces (F) (Fr) (Fx) (Fy) that act on the attachment members of The centrifugal force (Fc)=m.v²/r is decided by the mass (m) of the sliding member (42)(43), the radial distance (r) of the centre of gravity (43) to the first axis of rotation (0) (not shown here) and the transversal velocity (v) of the rotor (1) at the centre of gravity (44); and generates very high stresses in the sliding member (42)(43), that is, stresses (Fy=Fc) in the pivot members (45)(56) and stresses (Fx=Fc.a/b) in the lock members (95)(96). Pivoting attachment has the advantage that stresses due to torsion are largely avoided. Stresses in the lock members (95)(96) can be significantly reduced when the radial distance (b) between the lock member (95)(96) and the edge support location (97)(98) is increased and when the vertical distance (b) between the centre of gravity (44) and the pivot member (45)(56) is decreased.

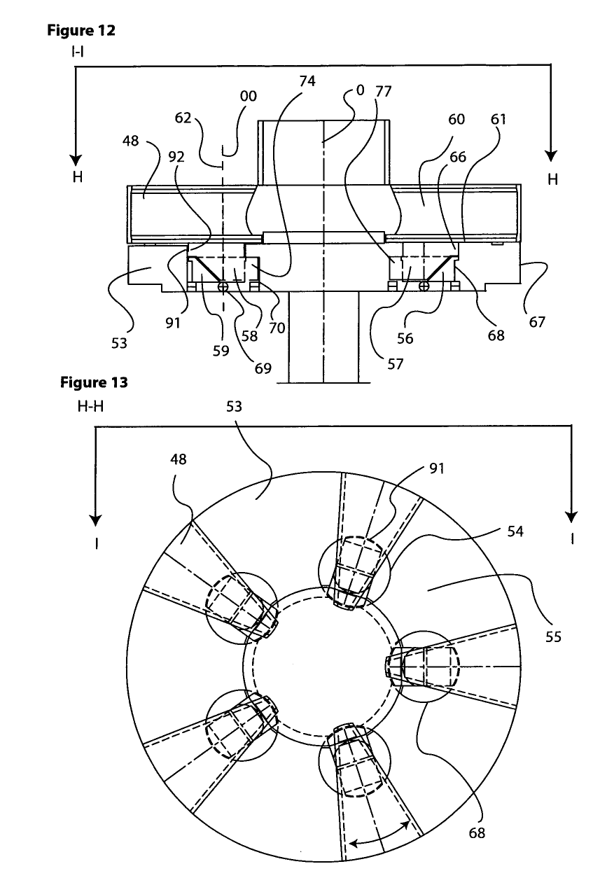

As is indicated in FIG. 11, the centre of gravity (47) of the sliding member (35) shift to a lower level—and more towards the first axis of rotation (0) (not shown here) when the sliding faces (49) are provided with chambers (50) and by inserting ceramic material inserts (51) that have much lower density than the metal in the sliding block (52)—which measures also increase lifetime and saves on wear material. Last but not least, at similar tip velocity, centrifugal force is significantly reduced when the radius of the rotor (r) (FIG. 3) is increased, hence the stresses that are generated in the sliding member (35).

When, for example in FIGS. 1 to 7, the first attachment member (8) is made out of a material that has a substantial higher tensile strength than the construction material from which the sliding block (7) is made—for example St 52—the high tensile strength allows for relative slim design.

Actually, with sliding blocks (7) of similar weight, a steel first attachment member (8) requires significant less weight when compared with the attachment member of the standard monometal sliding member (not shown here but discussed later)—providing lower weight and hence lower stresses, on the other hand it allows also for more block weight, hence longer operation time.

A monometal construction can be preferred in that these are somewhat easier to manufacture, although bimetal casting technology has improved significantly during recent years. Monometal construction also allows for ceramic inserts (51) that have proven to increase lifetime to significant degree, but ceramic inserts (51) are also possible with bimetal construction although manufacturing might be more complicated. One side pivoting sliding members (2) can be made monometal but these have to be provided with a thicker first lock member (19)—as will be shown later—and this goes at the expense of weight of the attachment member—but lowers the centre of gravity (43). The weight increase involves, however, only the first attachment member (8) and the overall weight increase means that a monometal one side pivoting sliding member (2) is of about similar weight compared with a ‘standard’ sliding member (not shown here) provided with similar weight sliding block (7)—and various construction are possible and can be imagined according to the invention here presented that allow for efficient use of wear material with monometal and bimetal one side pivoting sliding members (2) and does not affect the other advantages listed before.

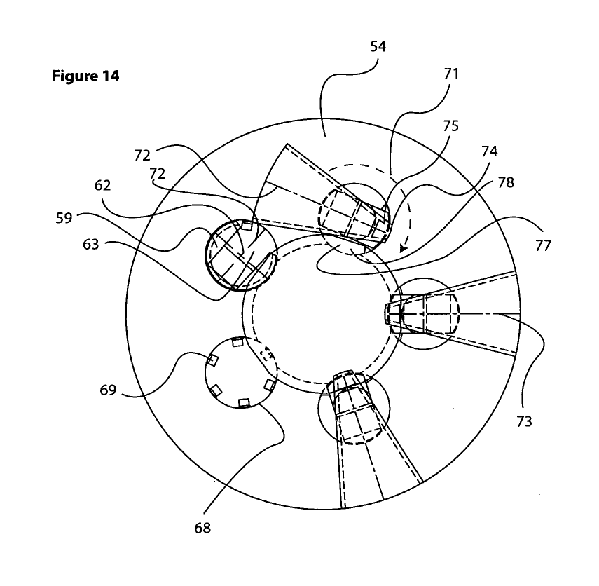

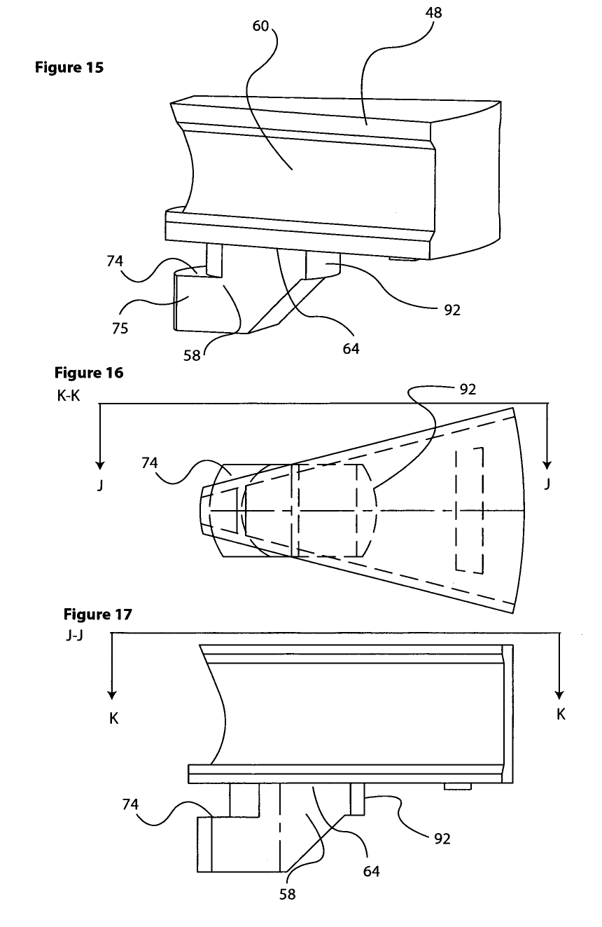

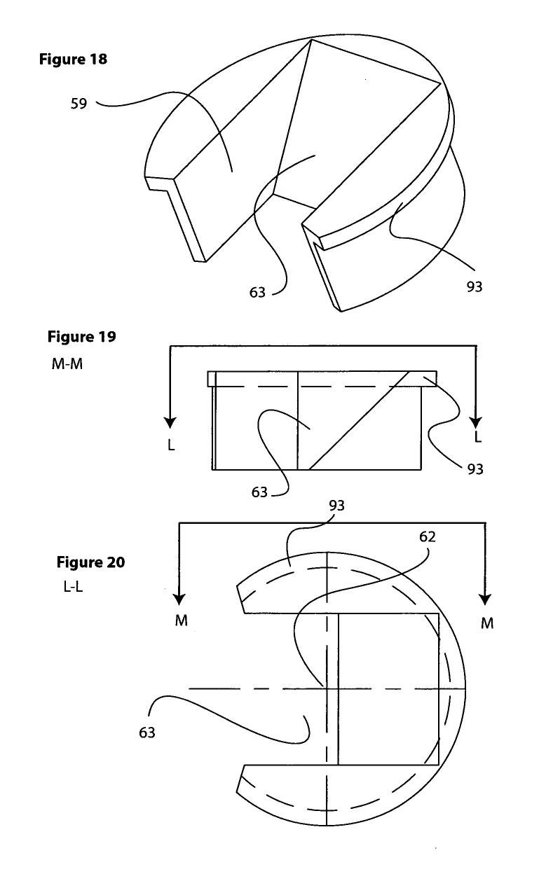

FIGS. 12 and 13 show, diagrammatically, a second embodiment of the rotor (53) that carries a second embodiment of a sliding member (48) according and to the invention. The sliding member is further detailed in FIGS. 15, 16 and 17. The sliding member (48) is here attached to the second pivot member (54), that here essentially consists out of a circular cylindrical attachment space (68) through the rotor (53) at a location in the surrounding face (55), with the aid of an adaptor (56). More specific, the first pivot member (57) is here out of two parts (58)(59), a connected pivot part (58) that is firmly joined with the sliding block (60) and a separate first pivot part (59), also called adaptor (56), that is carried by the rotor (53) in the attachment space (54) at a position essentially underneath the top (61) the surrounding face (55) of the rotor (53). The separate first pivot part (59) is detailed in FIGS. 18, 19 and 20 and consists here out of an essentially U-shaped block of circular cylindrical shape of which the centre line (62) provides the second axis of rotation (00). The U shape provides an open attachment slit (63), such that the connected pivot part (58) that protrudes from the bottom side (64) of the sliding block (60) and is firmly joined with the sliding block (60) fits the attachment slit (63) in the separate pivot part (59)—and the separate first pivot part (59) fits the second pivot member (65) which attachment provides the pivoting movement. The connected pivot part (58) is provided with a contact face (92) that is curved, such that it is makes close contact with the inner side (91) of the cylindrical attachment space (68) for transfer of the horizontal force (Fx from FIG. 8)—but does not hinder the pivoting movement. The separate first pivot part (59) is here carried by small support members (69) that protrude from the vertical side (70) of the second pivot part (65) to limit wear and the build up of particle material between the pivoting parts (59)(65). The separate first pivot member (59) it provided with a support edge (93) that provides support on the support members (69).

As is shown in FIGS. 14 the separate first pivot part (59) is placed in the attachment space (68) or second pivot member (65) and turned with the attachment slit (63) in transversal direction (72) such that sliding member (48) can be dropped in with the connected pivot part (58) into the open attachment slit (63) and is than turned (71) into its radial position (73) when the lock lip (74) of the first lock member (75) that protrudes from the first lock member (76) fits the lock space (77) of the second lock member (78) that is here constructed around the cylindrical attachment space (71) at the side (79) facing the first axis of rotation (0). This second embodiment of the sliding member (48) allows for a very thick first lock lip (74), which enables to construct the slide member (48) heavy weight out of monometal.

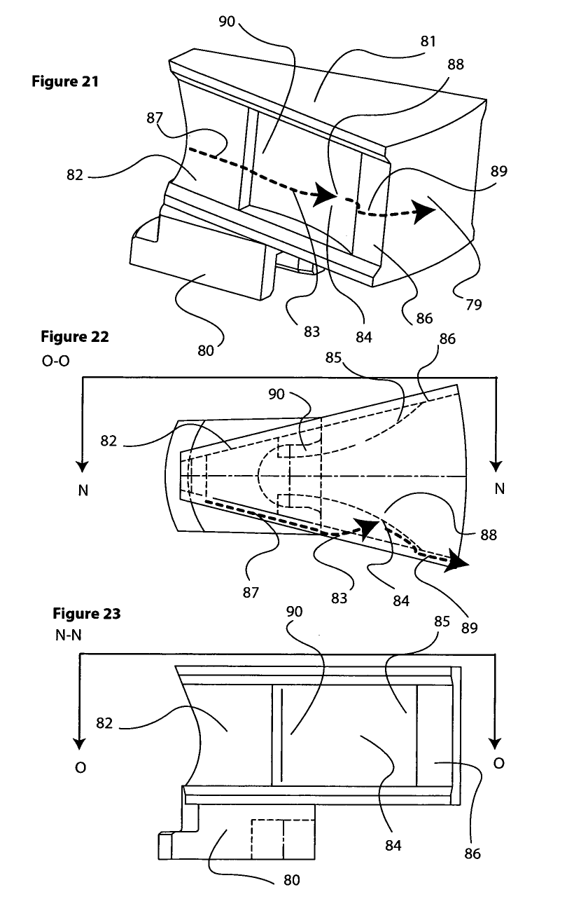

FIGS. 21, 22 and 23 show a third embodiment of the sliding member (79) provided with a first attachment member (80) essentially similar to that from the first embodiment of the sliding member (2) from FIG. 5, but the sliding block (81) is here provided with a short initial sliding face (82), such that the particle material moves away from the sliding block (81) to move along a short fight path (83) to an impact sliding face (84) that is positioned along the sliding face (85) at a greater radial distance form the axis of rotation (0) than the initial sliding face (82) to be further accelerated along the outer part (86) of the sliding face (85) before it is thrown away. This means that acceleration takes place in three steps—initial sliding (87), impact (88) and final sliding (89). This configuration allows for more efficient use of the wear material because initially no wear takes place along the centre part (90) of the sliding face (85) and the material is loaded during impact that contributes to comminution efficiency.

The above descriptions of specific embodiments of the present invention have been given with a view to illustrative and descriptive purposes. They are not intended to be an exhaustive list or to restrict the invention to the precise forms given, and having due regard for the above explanation, many modifications and variations are, of course, possible. The embodiments have been selected and described in order to describe the principles of the invention and the practical application possibilities thereof in the best possible way in order thus to enable others skilled in the art to make use in an optimum manner of the invention and the diverse embodiments with the various modifications suitable for the specific intended use. The intention is that the scope of the invention is defined by the appended claims according to reading and interpretation in accordance with generally accepted legal principles, such as the principle of equivalents and the revision of components.

1. Device for accelerating particle material comprising:
a rotor (1) of open type that is carried by a shaft (3) and is rotatable about an essentially vertically directed first axis of rotation (0) in at least one direction, which material is metered on the centre face (5) of the rotor (1), the outer edge (12) of which centre face (5) is surrounded by the surrounding face (6) of the rotor (1);
at least one sliding member (2) that is carried by the rotor (1) at a location essentially at the surrounding face (6) around the outer edge (12) of the centre face (5) from where the material is fed to the sliding member (2) that comprises a sliding block (7) that is provided with an attachment side (23) that carries a first attachment member (8) for attaching the sliding member (2) to a second attachment member (9) that is carried by the rotor (1) in such a way that the sliding block (7) can be exchanged for replacement because of wear, which sliding block (7) is provided with at least one sliding face (11) that is positioned essentially above the plane (22) with on it the outer edge (12) of the centre face (5) and stretches into the direction of the outer boarder (13) of the rotor (1) or beyond, between an inner face (14) that is directed towards the first axis of rotation (0) and an surrounding face (15), for accelerating the material under influence of centrifugal force, characterized in that:
the sliding member (2) is along the side (23) that faces the rotor (1) pivotly attached to the rotor (1) and centrifugally locked to the rotor (1) with the aid the first attachment member (8) and the second attachment member (9) which attachment members (8)(9) are both located at a position essentially below the plane (22) with on it the outer edge (12) of the centre face (5).

2. Device for accelerating particle material according claim 1, where the first attachment member consists out of a first pivot member and a first lock member, and the second attachment member is provided with a second pivot member and a second lock member, which first pivot member fits the second pivot member when it is attached to the rotor, such that the sliding member can pivot about a second axis of rotation that is essentially parallel to the first axis of rotation and is positioned at a shorter radial distance from the first axis of rotation than the centre of gravity of the sliding member when the sliding member is turned into its radial position, such that the first lock member fits the second lock member and secures the radial position of the sliding member through centrifugal locking, but does not hamper pivoting movement of the sliding member about the second axis of rotation when the sliding face wears off such that the centre of gravity shifts in transversal direction.

3. Device for accelerating particle material according claim 2, where the sliding member is out of one part with the attachment member firmly joined to the sliding block.

4. Device for accelerating particle material according claim 2, where the first pivot member is out of two parts, a connected pivot part that is firmly joined with the sliding block and a separate first pivot part that is carried by the rotor, such that the connected pivot part fits the separate pivot part and the separate first pivot part fits the second pivot member.

5. Device for accelerating particle material according claim 2, where the attachment members fit at a location essentially on top of the rotor.

6. Device for accelerating particle material according claim 2, where the attachment members fit at a location in an attachment space at a location essentially in the rotor.

7. Device for accelerating particle material according claim 2, where the attachment members fit at a location essentially partly in the rotor and partly on top of the rotor.

8. Device for accelerating particle material according claim 2, where the pivot members fit an attachment space at a location essentially in the rotor.

9. Device for accelerating particle material according claim 1, where the rotor has a stepped design such that the surrounding face of the rotor is located at a level below the plane with on it the outer edge.

10. Device for accelerating particle material according claim 1, where the sliding member is essentially symmetrical to the radial plane from the first axis of rotation for two-way operation of the rotor.

11. Device for accelerating particle material according claim 1, where the part of the sliding member hangs freely above the rotor.

12. Device for accelerating particle material according claim 1, where part of the sliding member protrudes over the outer border of the rotor.

13. Device for accelerating particle material according claim 1, where at least one sliding face is provided with at least one open chamber such that it at least partly fills with particle material under influence of centrifugal force.

14. Device for accelerating particle material according claim 1, where at least part of the first attachment member is made out of a structural material that has an appreciably greater tensile strength than the structural material from which the sliding block is made.

15. Device for accelerating particle material according claim 1, where the sliding block is provided with at least one inserted part that has an appreciably greater wear resistance than the structural material from which the sliding block is made.
